(19) United States
(12) Patent Application Publication
(10) Pub. No.: US 2026/0085757 A1
(43) Pub. Date: Mar. 26, 2026

(54) Control Valve Having Thermal Displacer for Limiting Thermal Conductivity

(71) Applicant: FISHER CONTROLS INTERNATIONAL LLC, Marshalltown, IA (US)

(72) Inventors: Lucas J. Schmitt, Conrad, IA (US); Aaron Anderson, Marshalltown, IA (US); Shane M. Johnson, Ames, IA (US); Lisa M Miller, Marshalltown, IA (US)

(21) Appl. No.: 18/895,979

(22) Filed: Sep. 25, 2024

(51) Int. Cl. F16K 27/02; F16K 41/10

(52) U.S. Cl. CPC F16K 1/36; F16K 1/04; F16K 27/02

(57) ABSTRACT

A control valve for use with process fluids at low temperatures. The control valve includes a valve body, a valve seat disposed in a fluid flow path of the valve body, a control element, and a valve stem coupled to the control element. The valve stem is configured to move the control element between a closed position, in which the control element sealingly engages the valve seat, and an open position, in which the control element is spaced from the valve seat. The control valve also includes an extension coupled to the valve body and including an extension cavity, a bonnet coupled to the extension to close the extension cavity, and a thermal displacer coupled to the valve stem and disposed within the extension cavity. The thermal displacer is configured to limit thermal conductivity between process fluid flowing through the fluid flow path and the bonnet.

### FIELD OF THE DISCLOSURE

The present disclosure generally relates to control valves, and, more particularly, to a control valve having a thermal displacer for limiting thermal conductivity between process fluid flowing through a valve body of the control valve and an extension coupled to the valve body.

### BACKGROUND

Process control systems typically include various components for controlling various process parameters. For example, a fluid process control system may include a plurality of control valves for controlling flow rate, temperature, and/or pressure of a process fluid flowing through the system. The end product is dependent on the accuracy of the control of these parameters, which is, in turn, dependent on the geometry and characteristics of the control valves. Control valves are, for example, specifically designed and selected to provide for particular flow capacities and pressure changes. When these characteristics are compromised, the quality of the end product may be affected.

Designing control valves for use with process fluids at low temperatures (e.g., temperatures between −452 degrees Fahrenheit and 300 degrees Fahrenheit) has proven difficult. Such control valves typically include a valve body through which low-temperature process fluid flows, a valve trim assembly, an extension coupled to the valve body (required when the valve trim assembly is removable), a bonnet coupled to the extension, and packing disposed in the bonnet to seal the extension from the environment surrounding the control valve. In operation, however, the extension tends to be filled with the low-temperature process fluid, which in turn thermally interacts with the packing and can reduce the temperature of the packing below allowable (and effective) temperatures.

### SUMMARY

In accordance with a first exemplary aspect of the present disclosure, a control valve is provided for use with process fluids at low temperatures. The control valve includes a valve body, a valve seat disposed in a fluid flow path of the valve body, a control element, and a valve stem coupled to the control element. The valve stem is configured to move the control element between a closed position, in which the control element sealingly engages the valve seat, and an open position, in which the control element is spaced from the valve seat. The control valve also includes an extension coupled to the valve body and including an extension cavity, a bonnet coupled to the extension to close the extension cavity, and a thermal displacer coupled to the valve stem and disposed within the extension cavity. The thermal displacer is configured to limit thermal conductivity between process fluid flowing through the fluid flow path and the bonnet.

In accordance with a second exemplary aspect of the present disclosure, a control valve is provided for use with process fluids at low temperatures. The control valve includes a valve body, a valve seat disposed in a fluid flow path of the valve body, a control element, and a valve stem coupled to the control element. The valve stem is configured to move the control element between a closed position, in which the control element sealingly engages the valve seat, and an open position, in which the control element is spaced from the valve seat. The control valve also includes an extension coupled to the valve body and including an extension cavity, a bonnet coupled to the extension to close the extension cavity, an actuator stem, a thermal displacer, and a stem connector configured to couple the actuator stem to the valve stem. The thermal displacer is configured to limit thermal conductivity between process fluid flowing through the fluid flow path and the bonnet and is retained within the extension cavity between the stem connector and the control element.

In accordance with a third exemplary aspect of the present disclosure, a control valve is provided for use with process fluids at low temperatures. The control valve includes a valve body, a valve seat disposed in a fluid flow path of the valve body, a control element, and a valve stem coupled to the control element. The valve stem is configured to move the control element between a closed position, in which the control element sealingly engages the valve seat, and an open position, in which the control element is spaced from the valve seat. The control valve also includes an extension coupled to the valve body and including an extension cavity, a thermal displacer disposed within the extension cavity and having a cylindrical body and a central aperture formed in the cylindrical body and sized to receive the valve stem to couple the thermal displacer to the valve stem. The thermal displacer is configured to limit thermal conductivity between process fluid flowing through the fluid flow path and the bonnet.

In further accordance with any one or more of the first, second, or third exemplary aspects of the present disclosure, the control valve can further include, in any combination, any one or more of the following preferred forms.

In one preferred form, the thermal displacer is made of a non-metallic material.

In another preferred form, the thermal displacer is made entirely of PTFE, PCTFE, or PEEK.

In another preferred form, a stem connector is coupled to the valve stem, and the thermal displacer is retained between the control element and the stem connector.

In another preferred form, the extension includes an extension body, and a clearance gap exists between an inner surface of the extension body and the thermal displacer.

In another preferred form, a guide sleeve is coupled to an end of the valve stem and/or a vapor barrier is disposed between the guide sleeve and the thermal displacer.

In another preferred form, a sealing element is at least partially disposed between the valve stem and the thermal displacer.

In another preferred form, the thermal displacer is clamped to the valve stem via the stem connector.

### BRIEF DESCRIPTION OF THE DRAWINGS

FIG. 1 is a perspective view of a first example of a control valve constructed in accordance with the teachings of the present disclosure.

FIG. 2 is a front, cross-sectional view of the first example of the control valve.

FIG. 3 is a detailed view of a portion of FIG. 2, showing a valve body and a valve trim assembly of the control valve.

FIG. 4 is a perspective view of a control element of the valve trim assembly of the first example of the control valve.

FIG. 5 is a detailed view of another portion of FIG. 2, showing an extension, a bonnet, and an actuator stem of the control valve.

FIG. 6 is a perspective view showing a stem connector that connects the actuator stem to a valve stem of the valve trim assembly of the first example of the control valve.

FIG. 7 is a perspective view of a thermal displacer configured to limit thermal conductivity in the first example of the control valve.

FIG. 8 is a detailed view of yet another portion of FIG. 2, showing the extension, the valve stem, the actuator stem, and the thermal displacer.

FIG. 9 is a detailed view of FIG. 8, showing the coupling between the valve stem and the thermal displacer.

FIG. 10 is a perspective view of FIG. 9.

FIG. 11 is a perspective view of a second example of a control valve constructed in accordance with the teachings of the present disclosure.

FIG. 12 is a cross-sectional view of FIG. 11.

FIG. 13 is a front, cross-sectional view of a thermal displacer of the second example of the control valve.

FIG. 14 is a detailed view of FIG. 12, showing the coupling between the thermal displacer and a valve stem of the second example of the control valve.

FIG. 15 is a front, cross-sectional view of a third example of a control valve constructed in accordance with the teachings of the present disclosure.

FIG. 16 is a front, cross-sectional view of a portion of a fourth example of a control valve constructed in accordance with the teachings of the present disclosure.

### DETAILED DESCRIPTION

It was previously understood that the undesirable thermal interactions between low-temperature process fluid and the packing disposed in the bonnet of these known control valves could be adequately addressed by leveraging thermal vapor barriers, either created naturally during use or physically installed in the bonnet. However, in practice, the inventors of the present disclosure have found that these thermal vapor barriers alone do not sufficiently limit the thermal interactions between the low-temperature process fluid and the packing in the manner required to protect the packing and other temperature sensitive components of these known control valves. And while other means and methods have been designed or utilized to address this problem, those means and methods are expensive and difficult to manufacture.

The inventors of the present application have therefore developed a control valve that addresses these problems in a cost-effective manner. More particularly, the inventors of the present application have developed a control valve that is easier and less costly to manufacture and more effectively minimizes the thermal interaction between low-temperature process fluid flowing therethrough and the temperature sensitive components of the control valve (e.g., packing disposed in a bonnet of the control valve).

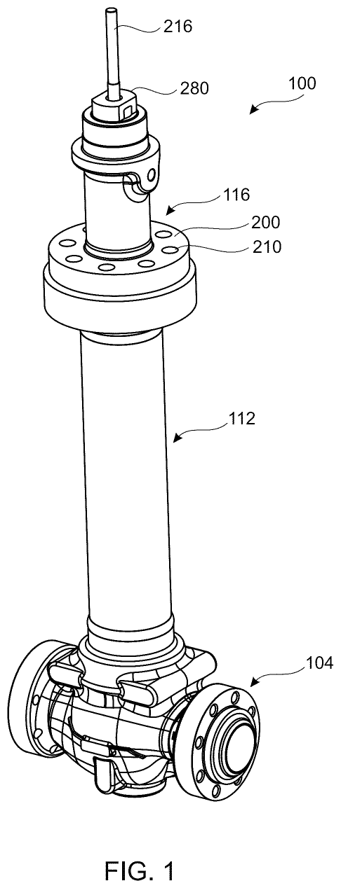

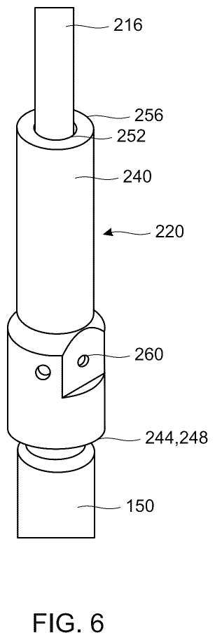

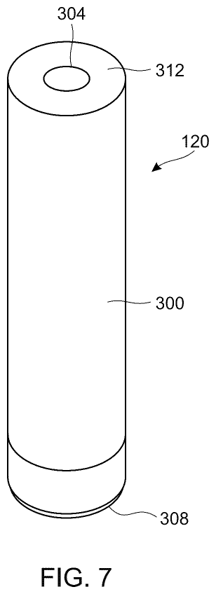

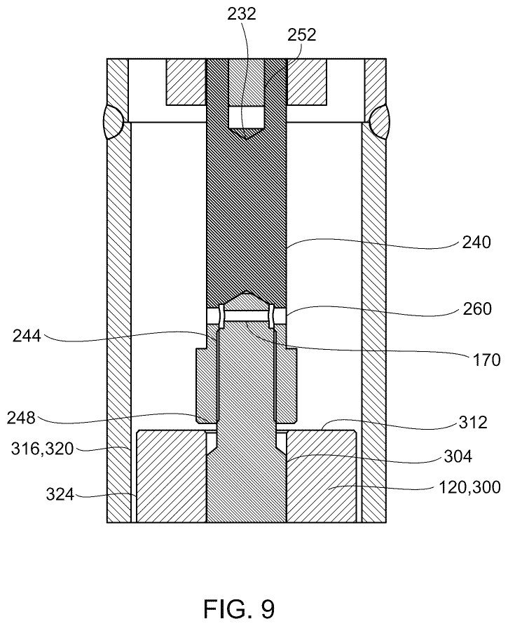

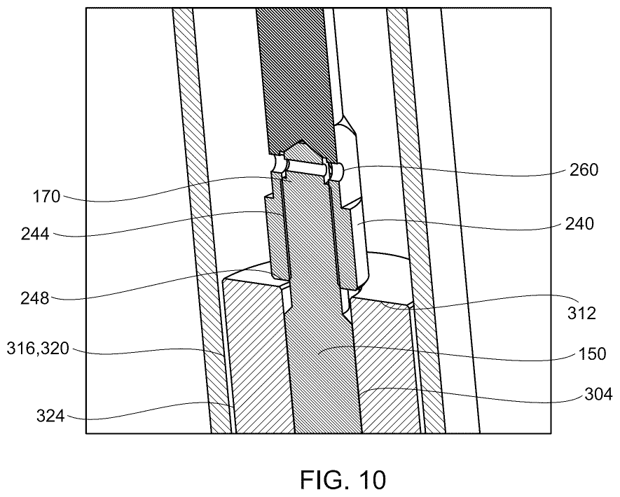

FIGS. 1-10 Illustrate one example of a control valve 100 constructed in accordance with the teachings of the present application. The control valve 100 is configured for use with a process fluid having a low temperature. The process fluid will generally have a temperature between −452 degrees Fahrenheit and 300 degrees Fahrenheit. In some cases, the process fluid will be a cryogenic fluid having a temperature less than −150 degrees Fahrenheit). The control valve 100 generally includes a valve body 104, a valve trim assembly 108, an extension 112, a bonnet 116, and a thermal displacer 120. The valve trim assembly 108 is at least partially disposed in the valve trim assembly 108, the extension 112 is coupled to the valve body 104 (and partially houses the valve trim assembly 108), and the bonnet 116 is coupled to the extension 112. The thermal displacer 120, meanwhile, is disposed within the extension 112 and is configured to limit thermal conductivity between low-temperature process fluid flowing through the valve body 104 and the rest of the control valve 100 (particularly the bonnet 116).

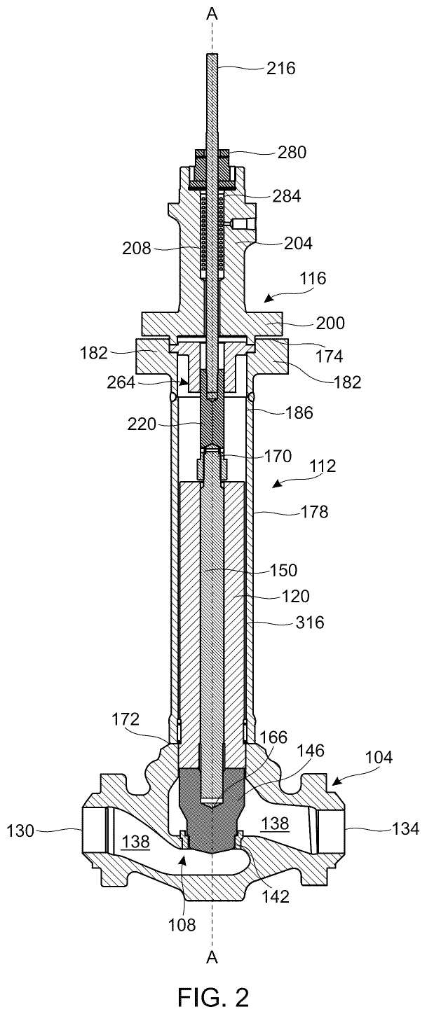

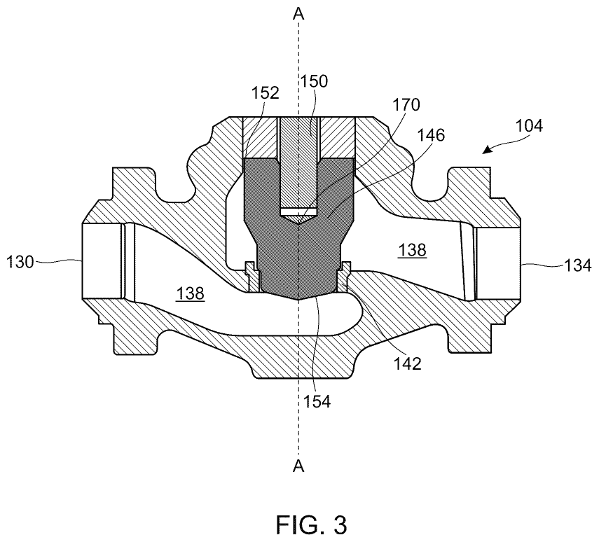

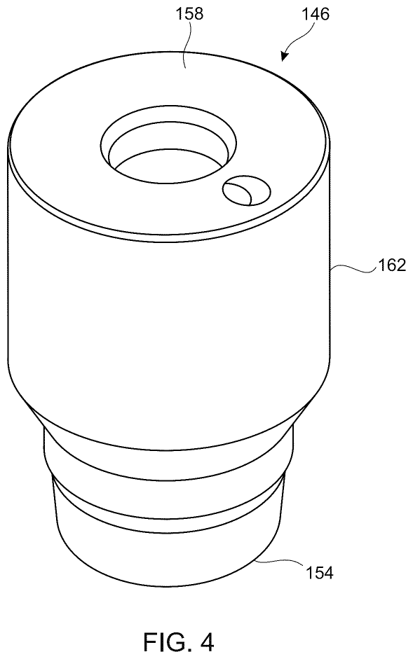

As best illustrated in FIGS. 2 and 3, the valve body 104 in this example is a globe-style valve body. The valve body 104 is preferably made of stainless steel, though the valve body 104 can instead be made of aluminum, another metallic material, various alloys, or combinations thereof. The valve body 104 defines an inlet 130, an outlet 134, and a fluid flow path 138 extending between the inlet 130 and the outlet 134. The valve trim assembly 108 is preferably made of stainless steel (e.g., S316000) or an alloy (e.g., R30016, R31233) but can instead be made of aluminum, another metallic material, or combinations thereof. The valve trim assembly 108 generally includes a valve seat 142, a control element 146, and a valve stem 150 coupled to the control element 146. The valve seat 142 is fixedly disposed in the fluid flow path 138. In this example, the valve seat 142 is a seat ring that is threaded to the valve body 104 within the fluid flow path 138. In other examples, however, the valve seat 142 can be welded, clamped, or otherwise coupled to the valve body 104. The control element 146 is movably disposed in the valve body 104 and relative to the valve seat 142 to control fluid flow through the fluid flow path 138. As best illustrated in FIGS. 3 and 4, the control element 146 in this example takes the form of an unbalanced valve plug having a first end 154, a second end 158 opposite the first end 154, and an external surface 162 that tapers from the second end 158 to the first end 154. In other examples, however, the control element 146 can take the form of a disk, a ball, or a different type of control element.

The valve stem 150 is movably disposed in both the valve body 104 and the extension 112. The valve stem 150 is cylindrical and has a first end 166 and a second end 170 that is opposite the first end 166 and is disposed within the extension 112, as best illustrated in FIGS. 2 and 3. In this example, the control element 146 is rigidly affixed to the first end 166 of the valve stem 150 via a pin (not shown) inserted into a hole (shown in FIG. 4) formed in the first end 154 of the control element 146. In other examples, however, the control element 146 can be pinned to the valve stem 150 in a different location or a different manner or the control element 146 can be welded, fastened, or otherwise coupled to the valve stem 150. In any event, the valve stem 150 is thus configured to move the control element 146 relative to the valve seat 142 to control the flow of low-temperature process fluid through the control valve 100. More particularly, the valve stem 150 is configured to move the control element 146 along a longitudinal axis A, relative to the valve seat 142, between a closed position (FIGS. 2 and 3) and an open position (not shown). When the control element 146 is in its closed position, the control element 146 sealingly engages the valve seat 142, thereby preventing the low-temperature process fluid from flowing from the inlet 130 to the outlet 134. Conversely, when the control element 146 is in its open position, the control element 146 is spaced from the valve seat 142, such that the low-temperature process fluid is allowed to flow into the inlet 130, through the fluid flow path 138, and out of the outlet 134.

The extension 112 is coupled to the valve body 104 to allow for the components of the trim assembly 108 to be removed from the valve body 104 and replaced or repaired when necessary. In this example, the extension 112 extends outward (upward in the orientation shown in FIG. 2) from the valve body 104 and is centered about the longitudinal axis A. Thus, at least in this example, the extension 112 has a first end 172 that is coupled to the valve body 104 and a second end 174 that is opposite the first end 172 and is spaced from the valve body 104. In this example, the extension 112 is welded to an exterior surface of the valve body 104 via the first end 172. In other examples, however, the extension 112 can be coupled to the valve body 104 in a different manner (e.g., via a plurality of bolts) and/or at a different location.

The extension 112 is preferably made of stainless steel, though the extension 112 can instead be made of aluminum, another metallic material, various alloys, or combinations thereof. The extension 112 generally includes an extension body 178, an extension flange 182 coupled to the extension body 178, and an extension cavity 186 defined by the extension body 178 and the extension flange 182. In this example, the extension body 178 defines the first end 172 of the extension 112 has a cylindrical shape, whereas the extension flange 182 defines the second end 174 of the extension 112.

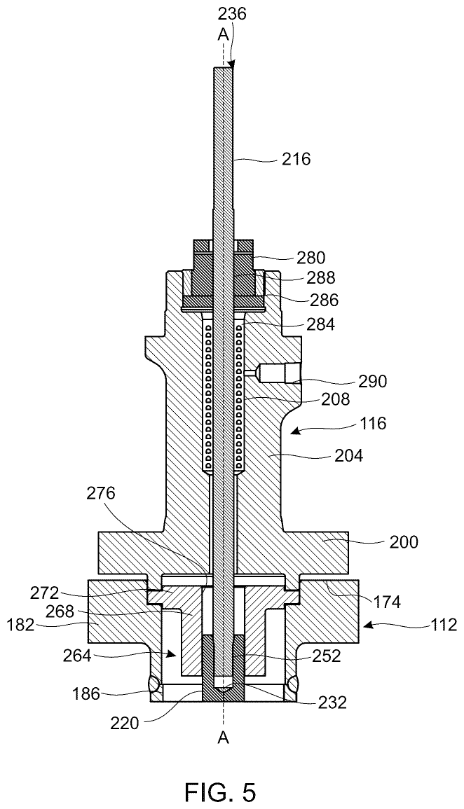

The bonnet 116 is coupled to the extension 112 such that the bonnet 116 is also centered about the longitudinal axis A and closes the extension cavity 186 defined by the extension body 178 and the extension flange 182. The bonnet 116 is preferably made of stainless steel, though the bonnet 116 can instead be made of another metallic material, various alloys, or combinations thereof. As best illustrated in FIGS. 2 and 5, the bonnet 116 generally includes a flanged portion 200, a substantially cylindrical neck 204 that extends outward (upward in the orientation shown in FIGS. 2 and 5) from the flanged portion 200, and a central passage 208 that extends through the flanged portion 200 and the neck 204. In this example, the bonnet 116 is coupled to the extension 112 via a plurality of fasteners (not shown) extending through a plurality of holes 210 (see FIG. 1) formed in the flanged portion 204 of the bonnet 116 and a plurality of corresponding holes (not shown) formed in the extension flange 182. In other examples, however, the bonnet 116 can be coupled to the extension 112 in a different manner.

As best illustrated in FIGS. 2, 5, and 6, the control valve 100 also includes an actuator stem 216 and a stem connector 220 that couples the actuator stem 216 to the valve stem 150 (and vice-versa). Like the valve stem 150, the actuator stem 216 is cylindrical and extends along the longitudinal axis A. However, the actuator stem 216 generally extends through and out of the bonnet 116. More particularly, the actuator stem 216 extends through and out of the central passage 208 of the bonnet 216 such that (i) a first end 232 of the actuator stem 216 is disposed in the extension cavity 186 and can be coupled to the stem connector 220, and (ii) a second, protruding end 236 of the actuator stem 216 can be coupled to an external actuator (not shown), such as a pneumatic actuator, an electric actuator, a mechanical actuator, or a manual actuator, for controlling the actuator stem 216 (and, in turn, the valve stem 150, via the stem connector 220).

As best illustrated in FIGS. 5, 6, and 8-10, the stem connector 220 in this example has a substantially cylindrical body 240, a valve aperture 244 formed in a first end 248 of the body 240, and an actuator aperture 252 that is separate from the valve aperture 244 and is formed in a second end 256 of the body 240. So configured, the second end 170 of the valve stem 150 is disposed in the valve aperture 244, and the first end 232 of the actuator stem 216 is disposed in the actuator aperture 252. The second end 170 of the valve stem 150 can be secured in the valve aperture 244 via one or more fasteners, welding, friction fit, or in some other manner. In this example, however, the second end 170 of the valve stem 150 is secured in the valve aperture 244 via a pin (not shown) that extends through a hole 260 formed in the body 240 and a corresponding hole (not shown) formed in the second end 170 of the actuator stem 150. Likewise, the first end 232 of the actuator stem 216 can be secured in the actuator aperture 252 via one or more fasteners, welding, friction fit, or in some other manner.

As best illustrated in FIGS. 2 and 5, the control valve 100 also includes a guide sleeve 264. The guide sleeve 264 is generally configured to guide movement of the actuator stem 216 and the stem connector 220 within the bonnet 116 and along the longitudinal axis A. To this end, the guide sleeve 264 is generally securely disposed within the extension 112 and/or the bonnet 116. In this example, the guide sleeve 264 has a sleeve body 268, a sleeve flange 272 that is coupled to and extends outward from the sleeve body 268, and a sleeve aperture 276 extending through the sleeve body 268 and the sleeve flange 272. In this example, the sleeve flange 272 is securely captured between the extension flange 182 and the flanged portion 200 of the bonnet 116, such that the sleeve body 268 is entirely (and securely) disposed in the extension cavity 186. So positioned, the sleeve aperture 276 receives (and guides) the actuator stem 216 and the stem connector 220 as the external actuator moves the actuator stem 216 (and, in turn, the valve stem 150 and the control element 146) as necessary to control fluid flow through the valve body 104.

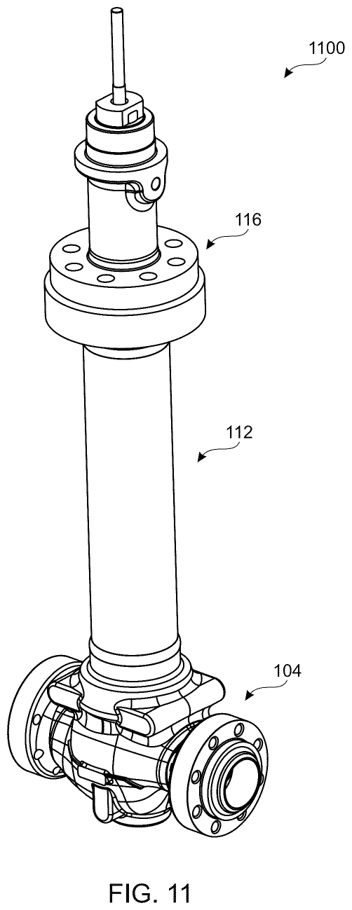

Further, the control valve 100 includes a packing nut 280 and a packing set 284. The packing nut 280 is generally configured to secure the packing set 284 within the central passage 208 of the bonnet 116 by applying a pre-determined load on the packing set 284. In this example, the packing nut 280 is at least partially disposed within a recess 286 formed in the neck 204 of the bonnet 116, and the actuator stem 216 is movably disposed in a central passage 288 formed in the packing nut 280. In other examples, however, the packing nut 280 can be coupled to the bonnet 116 in a different manner. Meanwhile, the packing set 284 is configured to prevent fluid leakage from the control valve 100 to the environment surrounding the control valve 100 via the bonnet 116. In this example, the packing set 284 is disposed in the central passage 208 of the bonnet 116, between the actuator stem 216 and neck 204 of the bonnet 116. Accordingly, at least in this example, the packing set 284 creates a sealing force between the actuator stem 216 and the bonnet 116 based on the pre-determined load applied to the packing set 284. As best illustrated in FIGS. 5 and 11, a hole is formed in the packing nut 280 that allows a user to increase or decrease the sealing force by, for example, manually tightening or loosening the packing set 284. Optionally, and as illustrated in FIG. 5, the bonnet 116 can also include a leak detection port 290 that is formed in the neck 204 and is fluidly connected to the central passage 208 (and the packing set 284). In turn, the leak detection port 290 can be used to detect pressure leakage through the bonnet 116 (and, more particularly, through the packing set 284).

As briefly discussed above, the thermal displacer 120 is configured to limit thermal conductivity between the interior of the valve body 104 (and, more particularly, the process fluid flowing through the fluid flow path 138) and the bonnet 116 (and, more particularly, the packing set 284 disposed in the central passage 208 of the bonnet 116). To this end, the thermal displacer 120 is coupled to the valve stem 150 and disposed within the extension cavity 186. In this example, the thermal displacer 120 has a solid, cylindrical body 300 and a stem passage 304 that is formed in the cylindrical body 300. The cylindrical body 300 is at least partially (and preferably entirely) made of a non-metallic material that has a low thermal conductivity and is generally chemically inert (so the thermal displacer 120 will not chemically react with any of the process fluid flowing through the control valve 100). The cylindrical body 300 is preferably made of PTFE, PCTFE, or PEEK, each of which has a low thermal conductivity and is generally chemically inert. The stem passage 304, meanwhile, is centrally located and extends between a first end 308 of the cylindrical body 300 and a second end 312 of the cylindrical body 300 opposite the first end 308.

In this example, the thermal displacer 120 is coupled to the valve stem 150 by way of the valve stem 150 being disposed in and extending through the stem passage 304 of the thermal displacer 120. In turn, an inner surface of the cylindrical body 300 engages or closely surrounds the portion of the valve stem 150 disposed in the stem passage 304. Moreover, the thermal displacer 120 is disposed within the extension cavity 186 at a position between the control element 146 and the stem connector 220. Indeed, at least in this example, the thermal displacer 120 engages both the second end 158 of the control element 146 and the first end 248 of the body 240 of the stem connector 220. And because the stem connector 220 has an outer diameter that is larger than an outer diameter of the valve stem 150 and the diameter of the stem passage 304, the stem connector 220 serves as a stop that engages the second end 312 of the cylindrical body 300 to prevent the thermal displacer 120 from moving beyond the stem connector 220 (and toward the bonnet 116). In other words, the thermal displacer 120 is securely retained in this position between the control element 146 and the stem connector 220.

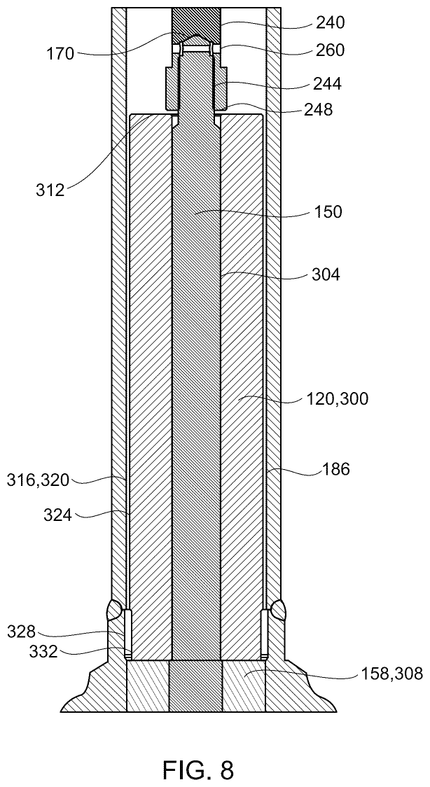

At the same time, the thermal displacer 120 is sized and disposed such that a narrow, radial clearance gap 316 exists between an inner surface 320 of the extension body 178 and the thermal displacer 120, which is best illustrated in FIGS. 2 and 8-10. More particularly, the clearance gap 316 is defined between the inner surface 320 of the extension body 178 and an outer surface 324 of the cylindrical body 300 of the thermal displacer 120. The clearance gap 316 extends the axial length of the cylindrical body 300 and is in turn in fluid communication with the portion of the extension cavity 186 between the thermal displacer 120 and the guide sleeve 264. As best illustrated in FIG. 8, the clearance gap 316 can be partially (or entirely) enlarged by way of forming an annular groove 328 in the inner surface 320 and/or an annular groove 332 in the outer surface 324 of the cylindrical body 300.

In operation, when low-temperature process fluid is flowing into the valve body 104 via the inlet 130, the external actuator controls the position of the actuator stem 216, which, in turn, controls the position of the valve stem 150 and the control element 146 carried by the valve stem as required for the desired application utilizing the low-temperature process fluid. In this manner, the external actuator can move the control element 146 between its closed position and its open position.

As discussed above, when the control element 146 is in its closed position, the control element 146 sealingly engages the valve seat 142, which prevents the low-temperature process fluid from flowing from the inlet 130 to the outlet 134. Moreover, a portion of the external surface 162 of the control element 146 engages an inner surface of the valve body 104, thereby inhibiting any low-temperature process fluid in the fluid flow path 138 and downstream of the control element 146 from flowing into and circulating within the extension cavity 186, which thereby improves the thermal performance of the control valve 100.

When the external actuator causes the valve stem 150 to move the control element 146 from its closed position to its open position, the control element 146 is moved upward, away from the valve seat 142, along the longitudinal axis A. In turn, the low-temperature process fluid is allowed to flow from the inlet 130 to the outlet 134 via the fluid flow path 138. Normally, the low-temperature process fluid would flow into and fill the extension cavity 186. However, because the thermal displacer 120 substantially fills the (lower) part of the extension cavity 186 closest to the fluid flow path 138, substantially all of the low-temperature process fluid that flows toward the extension cavity 186 will contact the thermal displacer 120. Because of the low thermal conductivity of the thermal displacer 120, the thermal displacer 120 will substantially absorb the (cold) thermal energy from the low-temperature process fluid. In other words, the thermal displacer 120 will substantially reduce the cold energy transferred through the extension 112 and to the bonnet 116. A small amount of the low-temperature process fluid that flows toward the extension cavity 186 will flow into the clearance gap 316. However, because the clearance gap 316 is narrow, and because of the axial length of the clearance gap 316, the outer surface 324 of the cylindrical body 300 of the thermal displacer 120 will thermally interact with the low-temperature process fluid as it flows up through the clearance gap 316, again substantially absorbing the (cold) thermal energy from the low-temperature process fluid. As a result, the thermal displacer 120 effectively thermally isolates the bonnet 116 (and, more particularly, the packing set 284 disposed in the bonnet 116) from the low-temperature process fluid. Accordingly, the temperature of the packing set 284 remains above allowable limits. Further yet, the inventors of the present disclosure discovered that absorption of the (cold) thermal energy by the thermal displacer 120 from the low-temperature process fluid has the unexpected benefit of also causing the thermal displacer 120 to thermally contract, which in turn ensures that the thermal displacer 120 continues to positively engage or closely surround the valve stem 150.

In some cases, and over time, the process fluid that does flow through the clearance gap 316 and into the upper part of the extension cavity 186, between the second end 312 of the thermal displacer 120 and the bonnet 116, may naturally create a vapor barrier within the extension cavity 186 as the temperature of the process fluid increases. Additionally or alternatively, the control valve 100 may be equipped with a physical vapor barrier (e.g., a sheet of plastic) that is disposed within the upper part of the extension cavity 186. In any event, the natural and/or physical vapor barrier can help to further thermally isolate the bonnet 116 (and, more particularly, the packing set 284 disposed in the bonnet 116) from the low-temperature process fluid that subsequently flows through the valve body 104. Moreover, in some cases, the control valve 100 can include one or more additional sealing elements to provide additional sealing functionality beyond what is described herein. For example, the control valve 100 can include a sealing element (e.g., a Bellows seal) in the extension cavity 186 and surrounding the valve stem 150 and/or the stem connector 220. The sealing element can be made of a metallic material or a non-metallic material that has a low thermal conductivity.

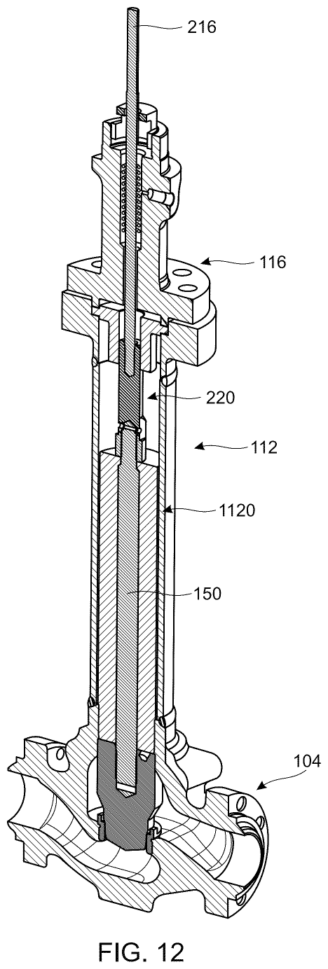

FIGS. 11-14 illustrate another example of a control valve 1100 constructed in accordance with the teachings of the present application. The control valve 1100 is identical to the control valve 100 with the exception that (1) the control valve 1100 includes a thermal displacer 1120 that is structurally different from the thermal displacer 120 of the control valve 100, and (2) the thermal displacer 1120 of the control valve 1100 is coupled to the valve stem 150 in a different manner than the thermal displacer 120 of the control valve 100 is coupled to the valve stem 150 of the control valve 100. More particularly, the thermal displacer 1120 is also clamped to the valve stem 150, providing an even more secure coupling between the thermal displacer 1120 and the valve stem 150.

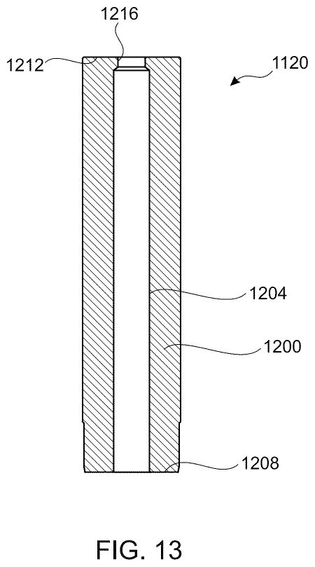

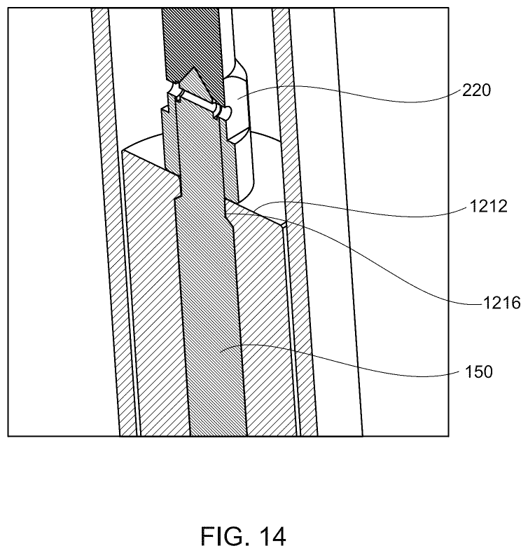

As best illustrated in FIG. 13, the thermal displacer 1120 has a solid, cylindrical body 1200 and a stem passage 1204 that is formed in the cylindrical body 1200. The solid, cylindrical body 1200 is generally similar to the cylindrical body 300 but has a first end 1208 and a second end 1212 opposite the first end 1208 that extends further radially inward than the rest of the cylindrical body 1200. In other words, the second end 1212 defines an inwardly extending annular projection 1216 that reduces the diameter of the stem passage 1204 at the second end 1212. Accordingly, when the valve stem 150 is disposed in and extends through the stem passage 1204 of the thermal displacer 1120, the projection 1216 is disposed in a small diameter section of the valve stem 150 and is clamped in position between the rest of the valve stem 150 and the stem connector 220, as best illustrated in FIG. 14. Notwithstanding these differences, the control valve 1100 is effectively functionally identical to the control valve 100.

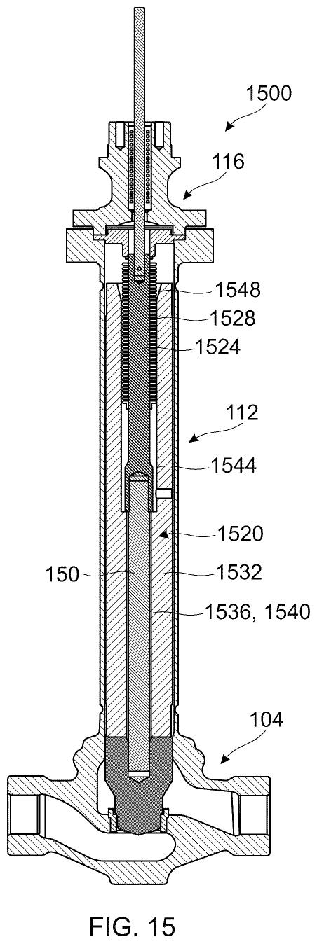

FIG. 15 illustrates another example of a control valve 1500 constructed in accordance with the teachings of the present application. The control valve 1500 is substantially similar to the control valve 100 but for the fact that (1) the control valve 1500 includes a thermal displacer 1520 that is structurally different from the thermal displacer 120 of the control valve 100, (2) the control valve 1500 includes a stem connector 1524 that is structurally different from the stem connector 220 of the control valve 100, and (3) the control valve 1500 includes a Bellows seal 1528 that is radially disposed between the thermal displacer 1520 and the stem connector 1524 to provide additional sealing functionality within the extension 112. As illustrated in FIG. 15, the thermal displacer 1520 has approximately same length as the extension 112, such that the thermal displacer 1520 is longer than the thermal displacer 120. Like the thermal displacer 120, the thermal displacer 1520 has a solid, cylindrical body 1532 and stem passage 1536 extending through the body 1532, but the stem passage 1536 has a first diameter portion 1540 that is generally equal to the diameter of the valve stem 150, a second diameter portion 1544 that is greater than the first diameter portion 1540, and a tapered portion 1548 that tapers radially outward from the second diameter portion 1544 to a second end 1552 of the body 1532. The second diameter portion 1544 is sized to accommodate a portion of the valve stem 150 and the stem connector 1524 as well as the bellows seal 1528, which is disposed in the stem passage 1536 and radially surrounds at least a portion of the stem connector 1524. While not specifically illustrated herein, it will be appreciated that the bellows seal 1528 can also be removed from the control valve 1500 (independently of the valve trim assembly 108) and replaced or repaired as needed. Finally, the stem connector 1524 has a length that is greater than the length of the stem connector 220. Notwithstanding these differences, the control valve 1500 is effectively functionally identical to the control valve 100.

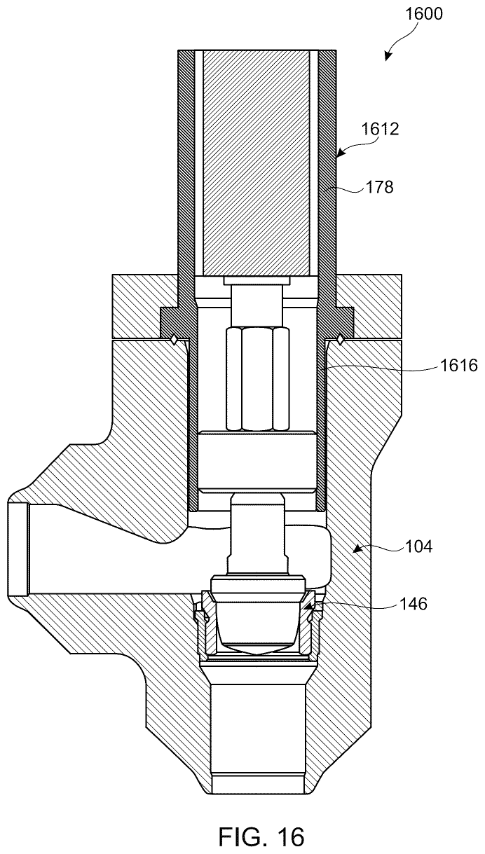

FIG. 16 illustrates a portion of another example of a control valve 1600 constructed in accordance with the teachings of the present disclosure. The control valve 1600 is identical to the control valve 1500 with two exceptions. First, the control valve 1600 has an extension 1612 that is different from the extension 112 of the control valve 100. In particular, the extension 1612 also has a guide sleeve 1616 that extends outward (downward in the orientation shown in FIG. 16) from the extension body 178. As such, the guide sleeve 1616 is positioned within the valve body 104 and helps to guide movement of the control element 146 between its closed and open positions. Second, the extension 1612 is coupled to the valve body 104 via a plurality of bolts (not shown) rather than being welded to the valve body 104.

1. A control valve, comprising:
a valve body defining an inlet, an outlet, and a fluid flow path extending between the inlet and the outlet;
a valve seat disposed in the fluid flow path;
a control element;
a valve stem coupled to the control element and configured to move the control element between a closed position, in which the control element sealingly engages the valve seat, and an open position, in which the control element is spaced from the valve seat;
an extension coupled to the valve body and comprising an extension cavity;
a bonnet coupled to the extension to close the extension cavity; and
a thermal displacer coupled to the valve stem and disposed within the extension cavity, the thermal displacer configured to limit thermal conductivity between process fluid flowing through the fluid flow path and the bonnet.

2. The control valve of claim 1, wherein the thermal displacer is made of a non-metallic material.

3. The control valve of claim 2, wherein the thermal displacer is made entirely of PTFE, PCTFE, or PEEK.

4. The control valve of claim 1, further comprising a stem connector coupled to the valve stem, wherein the thermal displacer is retained between the control element and the stem connector.

5. The control valve of claim 1, wherein the extension comprises an extension body, further comprising a clearance gap between an inner surface of the extension body and the thermal displacer.

6. The control valve of claim 1, further comprising a guide sleeve coupled to an end of the valve stem and a vapor barrier disposed between the guide sleeve and the thermal displacer.

7. The control valve of claim 1, further comprising a sealing element at least partially disposed between the valve stem and the thermal displacer.

8. A control valve, comprising:
a valve body defining an inlet, an outlet, and a fluid flow path extending between the inlet and the outlet;
a valve seat disposed in the fluid flow path;
a control element;
a valve stem coupled to the control element and configured to move the control element between a closed position, in which the control element sealingly engages the valve seat, and an open position, in which the control element is spaced from the valve seat;
an extension coupled to the valve body and comprising an extension cavity;
a bonnet coupled to the extension to close the extension cavity;
an actuator stem movably disposed in the bonnet;
a thermal displacer configured to limit thermal conductivity between process fluid flowing through the fluid flow path and the bonnet; and
a stem connector configured to couple the actuator stem to the valve stem, wherein the thermal displacer is retained within the extension cavity between the stem connector and the control element.

9. The control valve of claim 8, wherein the thermal displacer is made of a non-metallic material.

10. The control valve of claim 9, wherein the thermal displacer is made entirely of PTFE, PCTFE, or PEEK.

11. The control valve of claim 8, wherein the thermal displacer is clamped to the valve stem via the stem connector.

12. The control valve of claim 8, wherein the extension comprises an extension body, further comprising a clearance gap between an inner surface of the extension body and the thermal displacer.

13. The control valve of claim 8, further comprising a guide sleeve coupled to an end of the valve stem and a vapor barrier disposed between the guide sleeve and the thermal displacer.

14. The control valve of claim 8, further comprising a sealing element at least partially disposed between the valve stem and the thermal displacer.

15. A control valve, comprising:
a valve body defining an inlet, an outlet, and a fluid flow path extending between the inlet and the outlet;
a valve seat disposed in the fluid flow path;
a control element;
a valve stem coupled to the control element and configured to move the control element between a closed position, in which the control element sealingly engages the valve seat, and an open position, in which the control element is spaced from the valve seat;
an extension coupled to the valve body and comprising an extension cavity;
a bonnet coupled to the extension to close the extension cavity; and
a thermal displacer disposed within the extension cavity and having a cylindrical body and a central aperture that is formed in the cylindrical body and sized to receive the valve stem to couple the thermal displacer to the valve stem, the thermal displacer configured to limit thermal conductivity between process fluid flowing through the fluid flow path and the bonnet.

16. The control valve of claim 15, wherein the thermal displacer is made of a non-metallic material.

17. The control valve of claim 15, further comprising a stem connector coupled to the valve stem, wherein the thermal displacer is retained between the control element and the stem connector.

18. The control valve of claim 15, wherein the extension comprises an extension body, further comprising a clearance gap between an inner surface of the extension body and the cylindrical body of the thermal displacer.

19. The control valve of claim 15, further comprising a guide sleeve coupled to an end of the valve stem and a vapor barrier disposed between the guide sleeve and the thermal displacer.

20. The control valve of claim 15, further comprising a sealing element at least partially disposed between the valve stem and the thermal displacer.
